(19) United States
(12) Patent Application Publication
(10) Pub. No.: US 2014/0253778 A1
(43) Pub. Date: Sep. 11, 2014

(54) METHOD OF PROVIDING OSD IN MOBILE COMMUNICATION TERMINAL USING Q-CAMERA

(71) Applicant: PANTECH CO., LTD., Seoul (KR)

(72) Inventor: Yong Sik SHIN, Seoul (KR)

(73) Assignee: PANTECH CO., LTD., Seoul (KR)

(21) Appl. No.: 14/281,221

(22) Filed: May 19, 2014

Related U.S. Application Data
(63) Continuation of application No. 11/319,877, filed on Dec. 28, 2005, now abandoned.

(30) Foreign Application Priority Data
Dec. 28, 2004 (KR) 10-2004-0114161

(51) Int. Cl. H04N 5/232

(52) U.S. Cl. CPC H04N 5/23293
USPC 348/333.09

(57) ABSTRACT

A method of providing an on screen display (OSD) in a mobile communication terminal using a Q-camera includes: entering into a viewfinder mode, and receiving image data inputted from a camera sensor as image data of the viewfinder mode when an operation mode of the mobile communication terminal switches into a camera mode; if an OSD menu is set, merging an OSD image corresponding to a setting value of the OSD menu with the image data of the viewfinder mode, and then updating a display screen of the mobile communication terminal with the merged data; and encoding the image data of the viewfinder mode to perform the photographing if there is a request for photographing. The actually changed OSD image is selectively employed to merge with the image data of the viewfinder mode to update the display screen, and thereby a partial OSD function can be realized.

### CROSS REFERENCE TO RELATED APPLICATION

This application is a continuation of U.S. patent application Ser. No. 11/319,877, filed on Dec. 28, 2005, and claims priority from and the benefit of Korean Patent Application No. 10-2004-0114161, file on Dec. 28, 2004, all of which are hereby incorporated by reference for all purposes as if fully set forth herein.

### BACKGROUND

1. Field

The present invention relates to a method of providing an On Screen Display (OSD) in a mobile communication terminal using a Q-camera, and more particularly to a method of providing an OSD in a mobile communication terminal using a Q-camera allowing the terminal to provide a partial OSD function.

2. Discussion of the Background

As a development of technology for making mobile communication terminal, a complex mobile communication terminal having functions which have been provided by other electronic device, such as radio, TV, MP3 and the like, has been developed. In particular, a camera phone having a camera function added to the mobile communication terminal has been developed and widely used at present.

In the mean time, in technical field of semiconductors, there is a trend of which diverse functions are mounted in a single chip to reduce the number of parts, thereby reducing size and production cost of a product including the single chip. According to the trend, in technical field of mobile communication terminals, a function supporting digital camera referred to as ‘Q-camera’ comes to mount in a main chipset which provides a voice call function that is an inherent function of the mobile communication terminal, instead of mounting a single exclusive Back End IC capable of providing diverse camera functions.

However, unlike a mobile communication terminal using the single exclusive Back End IC (integrated circuit), a mobile communication terminal using the Q-camera cannot provide a partial OSD function in providing an OSD function. Thereby, the terminal can only display an OSD menu using an overwrite function and not an overlay function.

FIG. 1 is a flowchart for illustrating a method of providing an OSD in a mobile communication terminal using a Q-camera according to the prior art. Hereinafter, the OSD providing method of the prior art will be described with reference to FIG. 1.

Firstly, when an operation mode of the mobile communication terminal is switched into a camera mode by a user's key manipulation (S10), it is checked whether an OSD menu has been set or not, before entering into a viewfinder mode (S12).

As a result of the check of S12, if the OSD menu has not been set, a LCD screen of the mobile communication terminal is updated with image data inputted through a camera sensor as image data of the viewfinder mode (S14).

In the mean time, as a result of the check of S12, if the OSD menu has been set, it is searched all OSD images corresponding to setting values set through the OSD menu to select an OSD image corresponding to the setting value currently applied (S16), and the selected OSD image and the image data inputted through the camera sensor are merged (overwritten) (S18). After that, the overwritten data is used as the image data of the viewfinder mode to update the LCD screen (S20).

In the mobile communication terminal using the Q-camera, as can be seen from S20, since a partial OSD function is not supported in the prior method for providing OSD the terminal should have OSD images corresponding to all the setting values that can be set through the OSD menu. For example, if the terminal has two menus capable of setting seven-levels of brightness and seven-levels of shades, the mobile communication terminal should have 49 OSD images: {(brightness, shade): (−3, −3), (−3, −2), (−3, −1), (−3, 0), (−3, 1), (−3, 2), (−3, 3), . . . , (3, −3), (3, −2), (3, −1), (3, 0), (3, 1), (3, 2), (3, 3)}.

In addition, since each size of the OSD images should be same as a size of the LCD, if it is assumed that a size of a LCD is 220×176 (byte), a single OSD image occupies about 77 k byte of memory. In addition, the OSD image should be overwritten logically as much as 220×176 (byte) every time that the setting value of the menu is changed, in order to overwrite each of the OSD images with the image data inputted through the camera sensor.

When a user requests a photographing (S22) after updating the LCD screen (S20) as described above, it is checked whether the OSD image is applied to the image data of the viewfinder mode or not (S24).

As a result of the check of S24, if the OSD image is applied, since the OSD image should not be included in the image data of the viewfinder mode that is encoding data, the applied OSD image is deleted (S26) and then the data of which OSD image has been deleted are encoded (S28).

After performing the photographing through S22 to S28, when the operation mode of the terminal enters into a re-photographing mode (S30), if the OSD menu is set, the process proceeds to S12 since the OSD image should be again displayed on the LCD screen.

As described above, according to the mobile communication terminal using the Q-camera of the prior art, the terminal should have the OSD images corresponding to all the setting values capable of being set through the OSD menu, and the size of the OSD image is same as that of the LCD. Accordingly, the OSD images occupy considerable region of the limited memory. In addition, when a menu is added, all OSD images corresponding to the setting values of the added menu also should be added.

And, if the OSD menu is set, whenever it takes a photographing, an encoding process is performed after deleting the OSD image so that the data encoded by the encoding process do not include the OSD image. In addition, when the operation mode enters into the re-photographing mode, a setting of the OSD menu should be performed again, so that the whole system is applied with high load in photographing and thus instability can be caused in the system.

### SUMMARY

Accordingly, the present invention has been made to solve the above problems of the prior art. An object of the present invention is to provide a method of providing OSD in a mobile communication terminal using a Q-camera, wherein the method allows the terminal to embody a partial OSD function by selectively employing only an OSD image actually changed and merging the selected image with image data of a viewfinder mode to update a LCD screen.

In order to achieve the above objects, there is provided a method of providing an on screen display (OSD) in a mobile communication terminal using a Q-camera, comprising: entering into a viewfinder mode, and receiving image data inputted from a camera sensor as image data of the viewfinder mode when an operation mode of the mobile communication terminal switches into a camera mode; if an OSD menu is set, merging an OSD image corresponding to a setting value of the OSD menu with the image data of the viewfinder mode, and then updating a liquid crystal display (LCD) screen of the mobile communication terminal with the merged data; and encoding the image data of the viewfinder mode to perform the photographing if there is a request for photographing.

### BRIEF DESCRIPTION OF THE DRAWINGS

The above and other objects, features and advantages of the present invention will be more apparent from the following detailed description taken in conjunction with the accompanying drawings, in which:

FIG. 1 is a flowchart for illustrating a method of providing an OSD in a mobile communication terminal using a Q-camera, according to the prior art;

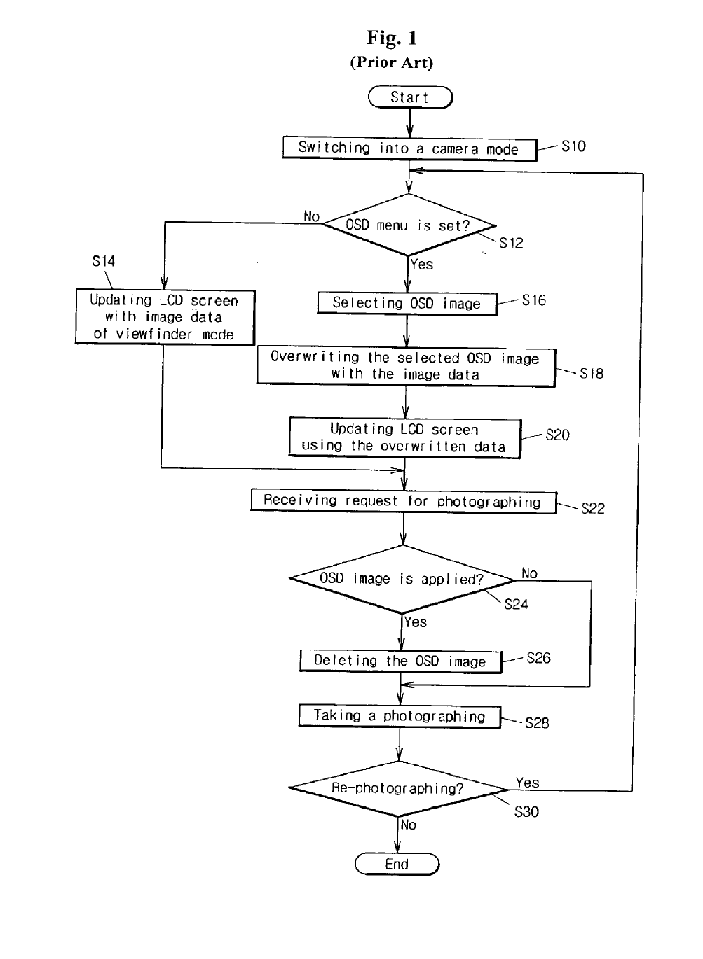

FIG. 2 is a flowchart for illustrating a method of providing an OSD in a mobile communication terminal using a Q-camera, according to an embodiment of the invention; and

FIG. 3 is a schematic diagram of an apparatus for embodying the method shown in FIG. 2.

### DETAILED DESCRIPTION

Hereinafter, preferred embodiments of the present invention will be described with reference to the accompanying drawings. In the following description of the present invention, a detailed description of known functions and configurations incorporated herein will be omitted when it may make the subject matter of the present invention rather unclear.

According to the invention, OSD images for all setting values capable of being set through an OSD menu are separately provided with respect to each of the menus. In other words, according to the invention, a single OSD image displays only a corresponding single menu instead of displaying all menus in a lump. Accordingly, for example, if two menus capable of setting seven-levels of brightness and seven-levels of shades are provided, 7 OSD images for the brightness menu and 7 OSD images for the shade menu, i.e. total 14 OSD images are required, as against the prior art requiring 49 OSD images.

In addition, according to the invention, a size of the OSD image is reduced as small as a region in which each of the menus is substantially displayed, as against the prior art making a size of the OSD image be same as that of the LCD.

Thereby, if a mobile communication terminal has two menus capable of setting seven-levels of brightness and seven-levels of shades, and a LCD having a size of 220×176 (byte), a memory of (220×176)×(7×7)×2 (byte) is required since a size of the OSD image is same as that of the LCD, according to the prior art. However, according to the invention in the above case, since the size of the OSD image is reduced as small as a region in which each menu is substantially displayed, it is required (18×18)×(7×2)×2 (byte) of memory only, if a size of a region in which a single menu is displayed is 18×18 (byte).

In addition, when the OSD image is merged with image data of the viewfinder mode, if only actually changed OSD image is selectively merged into a size of 18×18 (byte) which is a region corresponding to the actually changed OSD image, rather than a size of 220×176 (byte) which is a whole size of the LCD, the merging time also can be reduced by (220×176)/(18×18).

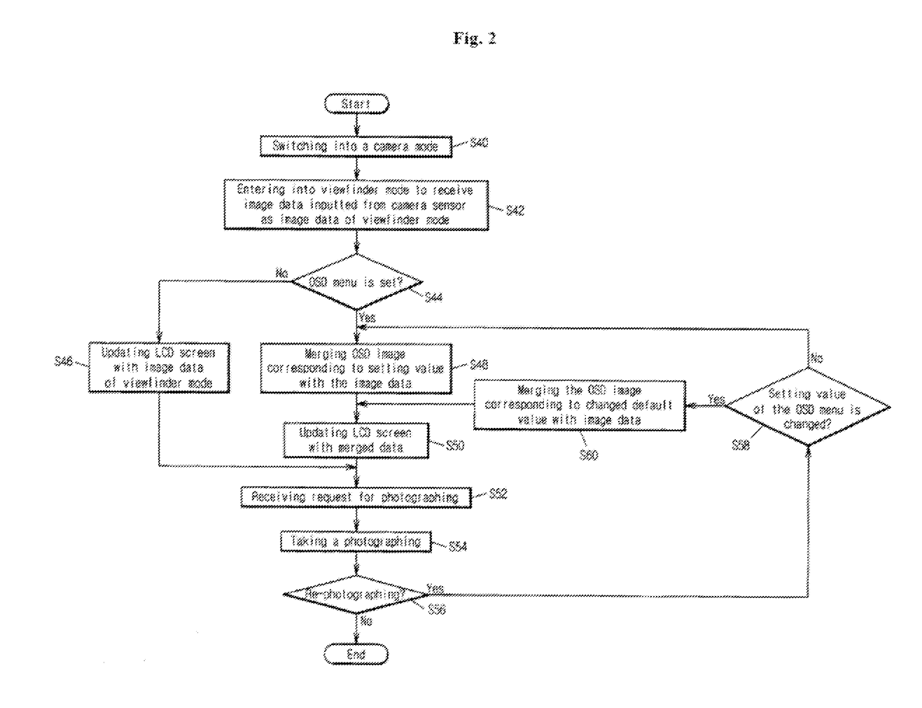

A method of providing OSD in mobile communication terminal using a Q-camera according to an embodiment of the present invention will be described with reference to FIG. 2.

Firstly, when an operation mode of the mobile communication terminal is switched into a camera mode by a user's key manipulation (S40), the terminal directly enters into a viewfinder mode. Then, the terminal receives image data inputted from a camera sensor as image data of the viewfinder mode (S42) and it is checked whether an OSD menu is set (S44).

As a result of the check of S44, if the OSD menu is not set, a LCD screen is updated with the image data of the viewfinder mode received via the step S42 (S46).

Meanwhile, as a result of the check of S44, if the OSD menu is set, the OSD image corresponding to the setting value of the OSD menu is merged with the image data of the viewfinder mode received in S42 (S48), and the LCD screen is updated with the merged data (S50).

The OSD image corresponding to the setting value of the OSD menu may be stored in a buffer for OSD image having the same size as LCD, and merged with the image data of the viewfinder mode, and then displayed on a LCD screen.

In addition, if at least two OSD menus are set, merging the OSD image with the image data in S48 can be performed with respect to each OSD image corresponding to each OSD menu. For example, in the event that both the OSD menu for ‘brightness’ and the OSD menu for ‘shade’ are set, the image data of the viewfinder mode may be separately merged with the OSD image corresponding to the setting value of the OSD menu for ‘brightness’ and with the OSD image corresponding to the setting value of the OSD menu on ‘shade’, respectively.

Then, if a request for photographing is received from the user (S52), the image data of the viewfinder mode is encoded to perform the photographing (S54). In case of entering into re-photographing mode (S56), it is checked whether the setting value of the OSD menu is changed according to the user's key manipulation (S58).

As a result of the check of S58, if the setting value of the OSD menu is not changed, a process proceeds to S48 to update LCD screen through merging an existing OSD image with newly received image data of the viewfinder mode.

In S54, the data that will be encoded according to the request for photographing of the user is image data of the viewfinder mode. Like this, since data to be encoded is checked before applying of the OSD image, it is not required to repeat the processes of deleting and resetting the OSD image upon every photographing like the prior art.

Meanwhile, as a result of the check of S58, if the setting value of the OSD menu is changed, newly received image data of the viewfinder mode and the OSD image corresponding to the changed setting value of the OSD menu are merged together (S60), and the LCD screen is updated with the merged data (S50).

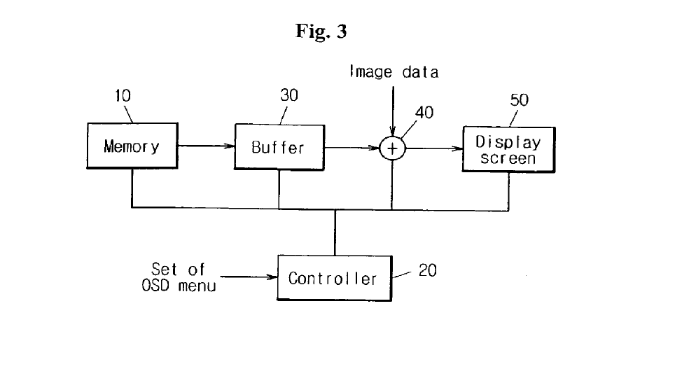

FIG. 3 is a schematic diagram of an apparatus for embodying the method shown in FIG. 2. As shown in FIG. 3, the apparatus for providing an OSD according to the invention comprises a memory 10, a controller 20, a buffer 30, a merger 40 and a display screen 50.

The memory 10 is an element for storing OSD images. Each of the OSD images stored in the memory is separately provided with respect to each menu instead of displaying all menus in a lump. For example, if two menus capable of setting seven-levels of brightness and seven-levels of shades are provided, 7 OSD images for the brightness menu and 7 OSD images for the shade menu, i.e. total 14 OSD images are stored in the memory.

In addition, each size of the OSD images stored in the memory may be set to have a size of a region that the OSD image is displayed on the display screen 50.

The controller 20 reads an OSD image corresponding to the setting value of an OSD menu from the memory 10, if the OSD menu is set. Then, the controller 20 merges the OSD image with the image data of the viewfinder mode through the merger 40, and displays the merged data on the display screen 50.

The buffer 30 is an element for buffering the OSD image readout from the memory by the controller. The buffered OSD image is merged with the image data of the viewfinder mode by controlling of the controller 20.

As described above, according to the method and apparatus for providing an OSD in the mobile communication terminal using Q-camera, only the actually changed OSD image is selectively employed to merge with the image data of the viewfinder mode to update the LCD screen, and thereby a partial OSD function can be realized. Accordingly, memory consumption due to unnecessary OSD images can be reduced, and a preview speed can be improved because it is required to merge only the changed OSD image selectively. In addition, with a solution to instability of the system caused by repeating deleting and resetting the OSD image upon every photographing, reliability of the system may be improved.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for providing an On Screen Display (OSD) in a mobile communication terminal using a Q-camera, comprising:
operating the mobile communication terminal in a camera mode;
entering into a viewfinder mode, and operating a camera sensor to generate image data of the viewfinder mode;
determining image data inputted from the camera sensor as the image data of the viewfinder mode, and displaying an image corresponding to the image data of the viewfinder mode on a display screen of the mobile communication terminal;
if an OSD menu for changing a color property of the image data of the viewfinder mode is selected, performing an OSD function by applying a color property changing OSD image corresponding to a color property setting value of the OSD menu on the image data of the viewfinder mode, and then updating the display screen of the mobile communication terminal with the color property changing OSD image and the image data of the viewfinder mode, the updated display screen displaying a changed color property applied on the image data of the viewfinder mode; and
receiving a request for photographing while the updated display screen of the mobile communication terminal is displayed,
wherein the color property changing OSD image is applied on the image data of the viewfinder mode such that only an OSD image actually changed is selectively employed.

2. The method according to claim 1, further comprising:
in a re-photographing mode, checking whether the color property setting value of the OSD menu is changed;
receiving newly received image data inputted from the camera sensor;
performing an OSD function by applying the color property changing OSD image on the newly received image data of the viewfinder mode to update the display screen, if the setting value of the OSD menu is not changed as a result of the check;
performing another OSD function by applying another color property changing OSD image corresponding to another color property setting value of the OSD menu on the newly received image data of the viewfinder mode to update the display screen, if the first setting value of the OSD menu is changed to the other color property setting value as a result of the check;
displaying a display screen of the mobile communication terminal in which the other color property changing OSD image corresponding to the other color property setting value of the OSD menu changes a color property of the newly received image data; and
encoding the newly received image data of the viewfinder mode in response to a request for re-photographing.

3. The method according to claim 1, wherein a separate color property changing OSD image is provided for each OSD menu, and each OSD menu corresponds to a color property setting of the display screen.

4. The method according to claim 1, wherein each color property changing OSD image is set to have a size of a region on which the color property changing OSD image is displayed on the display screen.

5. The method according to claim 1, wherein if two or more color property changing OSD menus are selected to be displayed on the display screen, a partial OSD function on each color property changing OSD image corresponding to one of the two or more OSD menus is separately performed with the image data, and each color property changing OSD menu corresponds to a color property setting of the display screen.

6. The method according to claim 5, further comprising: merging each of two or more color property changing OSD images on the image data of the viewfinder mode.

7. The method according to claim 1, wherein the color property setting value comprises at least one of a brightness value and a shade value.

8. A method for providing an On Screen Display (OSD) in a mobile communication terminal using a Q-camera, comprising:
operating the mobile communication terminal in a camera mode;
entering into a viewfinder mode, and operating a camera sensor to generate image data of the viewfinder mode;
determining image data inputted from the camera sensor as the image data of the viewfinder mode, and displaying an image corresponding to the image data of the viewfinder mode on a display screen of the mobile communication terminal;
if an OSD menu for changing a color property of the image data of the viewfinder mode is selected, performing a partial OSD function by applying a color property changing OSD image corresponding to a color property setting value of the OSD menu on a partial portion of the image data of the viewfinder mode, and then updating the display screen of the mobile communication terminal with the color property changing OSD image and the image data of the viewfinder mode, the updated display screen displaying a changed color property applied on the partial portion of the image data of the viewfinder mode, wherein the color property changing OSD image has a size smaller than a size of the image data of the viewfinder mode; and
receiving a request for photographing while the updated display screen of the mobile communication terminal is displayed.

9. The method according to claim 8, further comprising:
encoding the image data of the viewfinder mode to perform photographing in response to the request for photographing;
determining whether the color property setting value of the OSD menu is changed; and
if the color property setting value of the OSD menu is changed, selectively determining the color property changing OSD image from among a plurality of applied OSD images,
wherein the updating of the display screen is performed based on selective application of the selectively determined OSD image.

10. The method according to claim 9, wherein the plurality of applied OSD images comprise a brightness changing OSD image and a shade changing OSD image.

11. The method according to claim 8, wherein the color property changing OSD image is stored in a buffer for OSD images, the buffer having a size corresponding to a size of the image data of the viewfinder mode in the display screen.

12. A mobile communication terminal to provide an On Screen Display (OSD), comprising:
a memory to store OSD images, the OSD images comprising a color property changing OSD image;
a camera sensor to sense light to generate image data of a viewfinder mode in the viewfinder mode;
a controller to operate the mobile communication terminal in the viewfinder mode, to determine image data inputted from the camera sensor as the image data of the viewfinder mode, read the color property changing OSD image corresponding to a color property setting value from the memory on the image data of the viewfinder mode to perform an OSD function, and to update a display screen of the mobile communication terminal with the color property changing OSD image and the image data of the viewfinder mode, the updated display screen displaying a changed color property applied on the image data of the viewfinder mode;
a buffer to buffer at least one of the OSD images readout from the memory;
a user interface to receive a request for photographing while the updated display screen of the mobile communication terminal is displayed; and
a display screen to display the color property changing OSD image applied on the image data of the viewfinder mode,
wherein the color property changing OSD image is applied on the image data of the viewfinder mode such that only an OSD image actually changed is selectively employed.

13. The mobile communication terminal according to claim 12, wherein each OSD image stored in the memory corresponds to one OSD menu, and each OSD menu corresponds to one display setting of the display screen, and the color property changing OSD image corresponds to a brightness setting or a shade setting of the display screen.

14. The mobile communication terminal according to claim 12, wherein the controller encodes the image data of the viewfinder mode to perform photographing in response to the request for photographing.
